(19) United States
(12) Patent Application Publication
(10) Pub. No.: US 2004/0040925 A1
(43) Pub. Date: Mar. 4, 2004

(54) Portable lift apparatus

(76) Inventor: Glenn Harlan Miller, Orlando, FL (US)

Correspondence Address: LAW OFFICES OF JOHN D. GUGLIOTTA, P.E., ESQ., 202 DELAWARE BUILDING, 137 SOUTH MAIN STREET, AKRON, OH, 44308, US

(21) Appl. No.: 10/228,501

(22) Filed: Aug. 27, 2002

(51) Int. Cl. B66C 23/44

(52) U.S. Cl. 212/180

(57) ABSTRACT

The portable lift apparatus described herein, provides for the lifting of heavy objects such as motor vehicle engines, fence posts and the like. In the preferred embodiment, the portable lift apparatus has a base that attaches to a common receiver hitch attached to a vehicle or other heavy equipment. An upper arm extends upward at an angle. The main frame, of the portable lift apparatus in the preferred embodiment, is made of tubular stock that is welded together. A pulley wheel and a pair of cable guides route cable from a winch to the object desired to be moved. A removable support block cover covers the dolly wheel that is attached to the stabilizing jack. The dolly wheel allows for portability and the removable support block cover provides extra support for loads during lifting.

### RELATED APPLICATIONS

The present invention is a continuation of Disclosure Document Number 482,855 filed on Nov. 20, 2000.

### FIELD OF THE INVENTION

The present invention relates generally to lifts. More specifically, the present invention relates to a portable lift used to lift and move heavy objects.

### BACKGROUND OF THE INVENTION

There are many times when a heavy object must be lifted and typical aides such as cranes, tow motors, tow trucks or the like are neither available nor feasible. Examples of these tasks are the lifting of an engine out of a motor vehicle at a home garage or a small service center, the setting of fence posts or the lifting of heavy lumber at a farm or home. Usually in such instances a small hydraulic jack with a metal frame or casters must be rented—an item that is not very mobile especially over rough surfaces. Another common means of completing such tasks is the enlistment of the help of friends, neighbors or family, who may not be readily available or willing to help. Accordingly, there exists a need for a means by which heavy loads can be lifted in a simple manner without the above listed disadvantages. The present invention fulfills this need.

### SUMMARY OF THE INVENTION

The present invention, the portable lift apparatus, provides for the lifting of heavy objects such as motor vehicle engines, fence posts and the like. In the preferred embodiment, the portable lift apparatus attaches to a common receiver hitch and extends out from the rear of a vehicle. An upper arm extends upward at an angle of approximately sixty degrees to a total height of approximately ninety-nine inches. The main frame of the portable lift apparatus in the preferred embodiment, is made of two inch tubular stock that is welded together. Also in the preferred embodiment, a pulley and a cable guide route a high strength steel cable to either a manual or an electric winch. A support plate or dolly wheel provides extra support for loads up to one thousand pounds when the lift is constructed from aluminum and up to fifteen hundred pounds when the lift is constructed from steel.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a side view of the portable lift apparatus with the dolly wheel in use.

FIG. 2 is a side view of the portable lift apparatus with the support plate in use.

FIG. 3 is a front view of the portable lift apparatus.

### DETAILED DESCRIPTION OF THE INVENTION

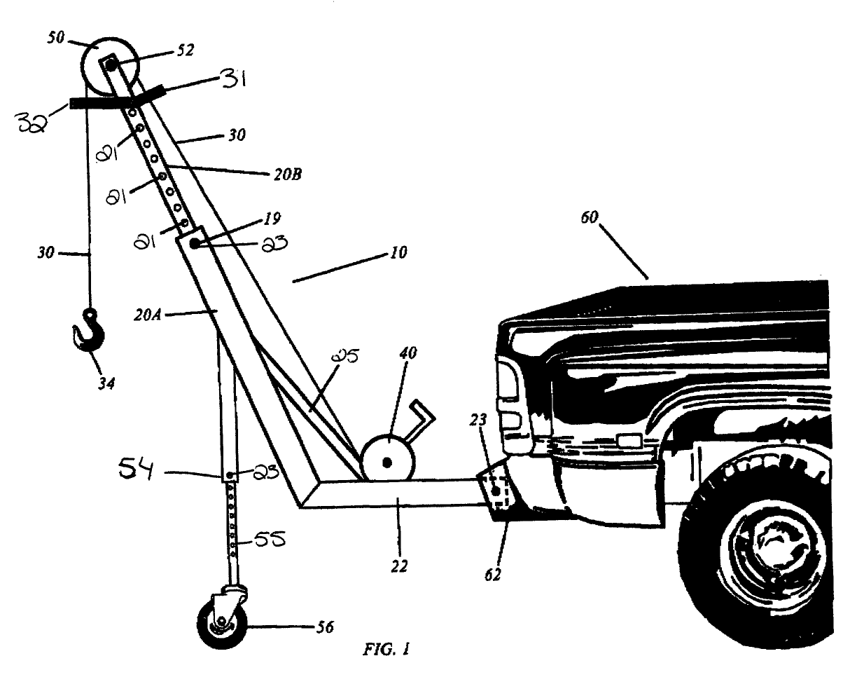

The preferred embodiment of the present invention, the portable lift apparatus 10 is shown in FIGS. 1-3. In the preferred embodiment, the main body pieces 20, 22, 25, 54 of the portable lift apparatus 10 are constructed from aluminum. One of ordinary skill in the art would readily recognize that other materials, including, but not limited to, steel can be used to make the portable lift apparatus 10. The overall cost of manufacture and strength of the apparatus 10, both depend on the type of material chosen to construct the main body pieces 20, 22, 25, 54.

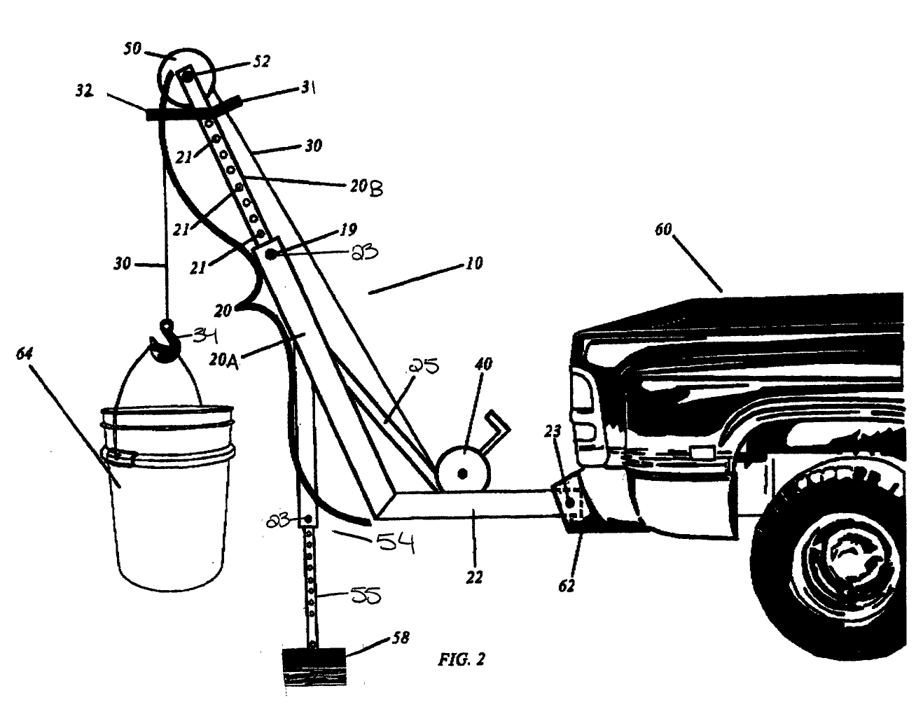

As can be seen in both FIGS. 1 and 2, the portable lift apparatus 10 has a base 22. Said base 22 is preferably devised to mate at one end thereof with a standard female hitch 62 mounted to a motor vehicle 60. The base 22 can be adapted to fit a receiver 62 from one and one-quarter inches to two inches in size. In the preferred embodiment, a five-eighths inch hitch pin 23 is used to fasten the portable lift apparatus 10 to a motor vehicle. A safety clip (not shown) is preferably used to secure the base 22 in place. One of ordinary skill in the art would readily recognize that a safety clip need not be used and that the hitch pin 23 can be any number of different sizes such that it coordinates with the hitch being used.

In the preferred embodiment, attached to the end of the base 22 opposite the end that is devised to engage a vehicle hitch, preferably by being welded thereto, is the boom 20. It is preferred that the boom 20 be welded to the base 22 at an upward angle for maximum strength and stability. This is preferably achieved by using a miter saw to cut the base 22 at a seven degree angle and then mating the boom 20 therewith. One of ordinary skill in the art would recognize, however, that the size of the angle can be altered. The totality of the boom 20 encompasses a lower boom 20A and an upper boom 20B. The upper boom 20B fits inside of the lower boom 20A such that the boom 20 is telescoping in nature and the height thereof can be easily adjusted. In the preferred embodiment, a five-eighths inch hitch pin 23 is used to secure the upper boom 20B after it has been extended. The hitch pin 23 is inserted through the single aperture 19 at the highest end of the lower boom 20A and through the nearest aperture 21 on the upper boom 20B. One of ordinary skill in the art would readily recognize that the hitch pin 23 need not be a five-eighths inch pin and can be any number of sizes. The size of the hitch pin 23 must coordinate, however, with the size of the single aperture 19 in the lower boom 20A and the apertures 21 in the upper boom 20B. In the preferred embodiment, the maximum length of the boom 20 is four and one-half feet in its extended position, and the minimum length of the boom is four feet, in its retracted position. One of ordinary skill in the art would recognize that although the length of the boom 20 can be shorter that four feet, it is not safe for the length of the boom 20 to be longer that four and one-half feet and still lift up to one thousand pounds, unless other structural changes, such as constructing the main body pieces, 20, 22, 25 and 54 from steel instead of aluminum, are made in the portable lift apparatus 10. The total vertical height, in the preferred embodiment, from the ground to the top of the boom 20, when fully extended, is ninety-nine inches such that fence posts and poles up to fifteen feet in length can be handled and installed. In the preferred embodiment, the main frame of the portable lift apparatus 10, including the base 22 and the boom 20 is constructed from two inch tubular metal stock. As mentioned above, it is preferred that the portable lift apparatus 10 be constructed from steel or aluminum for structural integrity and strength. One of ordinary skill in the art would recognize that the portable lift apparatus 10 can be made out of a different size tubular stock. Doing so adjusts the weight and size handling capabilities of the portable lift apparatus 10.

Located at the highest end of the upper boom 20B in the preferred embodiment, is a pulley wheel 50, preferably made of steel and three inches in size, together with a bolt 52 to fasten it in place, preferably five-eighths of an inch to one-half inch in size, and a brass sleeve bushing. One of ordinary skill in the art would readily recognize that the size of the pulley wheel 50 and its accessories can vary as can the material that each is constructed from. The pulley wheel 50, in the preferred embodiment, further has a plate, preferably stainless steel, over the center thereof to protect the pulley wheel 50 and prevent the cable from jumping off of the pulley.

In the preferred embodiment, steel cable 30 is used to lift and move heavy objects. One of ordinary skill in the art would readily recognize that other types of cable, including but not limited to, aluminum cable can be used on the portable lift apparatus 10. The cable 30 is wound around a manual or electronic winch 40. In the preferred embodiment, the cable 30 is then fed parallel along the boom 20, through a hardened steel cable guide 31, preferably sized one-half inch by two inches, and located just below the pulley wheel 50, over the pulley wheel 50 and down through a second cable guide 32. In the preferred embodiment, the cable guides 31, 32 have a one-quarter inch aperture through which the cable 30 is fed. The cable guides 31, 32 work to keep the cable 30 centered in the pully; when pulling off-center of the boom 20 during the lifting and moving of heavy objects 64. In the preferred embodiment, the bottom of the cable guides 31, 32 will be chamfered, allowing the cable 30 to move freely in all directions.

In an alternative, aluminum, embodiment of the portable lift apparatus 10, a three-fourths inch by one inch solid piece of aluminum with a one-quarter inch chamfered steel guide insert pressed therein will serve to guide the cable 30.

The end of the cable 30 preferably has a hook 34 coupled thereto for fastening to and around heavy objects that need to be lifted and/or moved. Although either a manual or an electronic winch 40 can be used with the portable lift apparatus 10, it is preferred that a twelve volt DC, one ton, free spooling electronic winch be used. One of ordinary skill in the art would readily recognize, however, that a variety of similar electronic winches can be substituted for the electronic winch specified herein. If a manual winch is used, it is preferred that said winch be a free spooling twelve hundred pound manual winch with forward and reverse lock. Again, one of ordinary skill in the art would readily recognize that a variety of similar manual winches can be substituted for the manual winch specified herein.

In the preferred embodiment, a stabilizing jack 54 is attached to directly to the lower end of the boom 20A. The stabilizing jack 54 of the preferred embodiment has a crank handle 55 to adjust the height of the stabilizing jack 54. In the preferred embodiment, a dolly wheel 56 is attached to lowest end of the telescoping leg 55 of the mechanical screw type stabilizing jack 54. In the preferred embodiment, a dolly wheel 56 is attached to the lowest end of the crank handle 55. The dolly wheel 56 is used during transportation of the portable lift apparatus 10. The preferred embodiment further has a support block cover 58, preferably square in shape, into which the dolly wheel 56 is removably inserted to prevent movement, when extra support is needed during lifting. Both the dolly wheel 56 and the support block cover 58 serve as additional support to the portable lift apparatus 10.

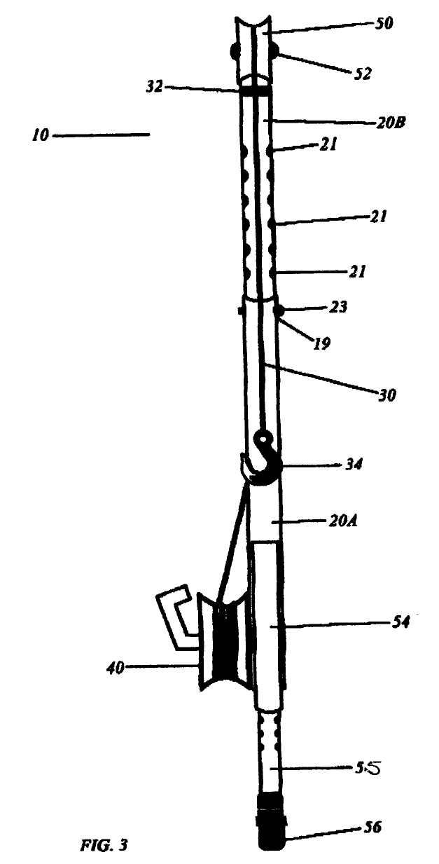

FIG. 3 illustrates a front view of the portable lift apparatus 10.

To use the portable lift apparatus 10, the user simply inserts the male hitch engaging end of the base 22 into the female receiver hitch 62 mounted on any given vehicle 60. The user then pushes the hitch pin 23 into place and fastens a safety clip. If needed, the user now extends the upper boom 20B. To do this, the hitch pin 23 is removed and the upper boom 20B is manually extended. Once the boom 20 is the total length needed, the hitch pin 23 is reinserted through aperture 19 and the nearest aperture 21 to lock the upper boom 20B in place. The hitch pin 23 is then secured using a safety clip. Now, using a winch 40, the user can lower or raise the cable 30 and hook 34. Once the hook 34 is securely fastened on or around the object 64 to be moved, the winch 40 is used to lift said object 64. The load of the object 64 is supported by the dolly wheel 56 or the support block cover 58.

The motor vehicle 60 to which the portable lift apparatus 10 is attached, gives the portable lift apparatus 10 its leverage. Consequently, said motor vehicle 60 should weigh more than the object 64 that the user is lifting or moving.

Although this invention has certain preferred embodiments, it will be obvious to those skilled in the art that various changes and modifications may be made therein without departing from the invention, and all such changes and modifications are intended to fall within the true spirit and scope of the invention.

What is claimed is:

1. A portable lift apparatus comprising:
a base, said base having a first end and a second end, the first end of the base devised to matingly engage a vehicle hitch;
a boom coupled to the second end of the base at an upward angle;
a stabilizing jack having a first end and a second end, said stabilizing jack coupled at its first end to the center of the boom, said stabilizing jack having a telescoping leg extending from within the second end of the stabilizing jack such that the height of the stabilizing jack can be adjusted;
a pulley wheel connected to the highest end of the boom such that said pulley wheel is allowed to spin around the connection axis; and,
a winch coupled to the base.

2. The portable lift apparatus of claim one, further comprising a plate extending over the pulley wheel such that said plate does not hinder the movement of cable over the pulley wheel and prevents cable running over the pulley wheel from jumping and moving off of the pulley wheel.

3. The portable lift apparatus of claim one, further comprising a pair of cable guides coupled to the upper part of the boom below and above the pulley wheel, to guide the cable around the pulley wheel.

4. The portable lift apparatus of claim one, further comprising:
a dolly wheel coupled to the telescoping leg of the stabilizing jack; and,
a support block cover removably attached to the dolly wheel.

5. A portable lift apparatus comprising:
a base, said base having a first end and a second end, the first end of the base devised to matingly engage a vehicle hitch;
a boom, said boom having a lower part and an upper part, the lower part of the boom coupled to the second end of the base at an upward angle, the upper part of the boom telescoping from within the lower part of the boom such that the length of the boom can be extended by extending the upper boom;
a stabilizing jack coupled to the lower part of the boom, said stabilizing jack having a telescoping leg such that the height of the stabilizing jack can be adjusted;
a pulley wheel connected to the highest end of the upper part of the boom such that said pulley wheel is allowed to spin around the connection axis; and,
a winch coupled to the base.

6. The portable lift apparatus of claim five, further comprising a plate extending over the pulley wheel such that said plate does not hinder the movement of cable over the pulley wheel and prevents cable running over the pulley wheel from jumping and moving off of the pulley wheel.

7. The portable lift apparatus of claim five, further comprising a pair of cable guides coupled to the upper part of the boom below and above the pulley wheel, to guide the cable around the pulley wheel.

8. The portable lift apparatus of claim five, further comprising:
a dolly wheel coupled to the telescoping leg of the stabilizing jack; and,
a support block cover removably attached to the dolly wheel.

9. A portable lift apparatus comprising:
a base, said base having a first end and a second end, the first end of the base devised to matingly engage a vehicle hitch;
a boom, said boom having a lower part and an upper part, the lower part of the boom coupled to the second end of the base at an upward angle, the upper part of the boom telescoping from within the lower part of the boom such that the length of the boom can be extended by extending the upper boom;
a main boom brace for providing additional support to the boom, said main boom brace coupled at one end thereof to the base and coupled at the opposite end thereof to the lower part of the boom;
a stabilizing jack coupled to the lower part of the boom, said stabilizing jack having a telescoping leg such that the height of the stabilizing jack can be adjusted;
a pulley wheel connected to the highest end of the upper part of the boom such that said pulley wheel is allowed to spin around the connection axis; and,
a winch coupled to the base.

10. The portable lift apparatus of claim nine, further comprising a plate extending over the pulley wheel such that said plate does not hinder the movement of cable over the pulley wheel and prevents cable running over the pulley wheel from jumping and moving off of the pulley wheel.

11. The portable lift apparatus of claim nine, further comprising a pair of cable guides coupled to the upper part of the boom below and above the pulley wheel, to guide the cable around the pulley wheel.

12. The portable lift apparatus of claim nine, further comprising:
a dolly wheel coupled to the telescoping leg of the stabilizing jack; and,
a support block cover removably attached to the dolly wheel.
